(19) United States
(12) Patent Application Publication
(10) Pub. No.: US 2010/0067604 A1
(43) Pub. Date: Mar. 18, 2010

(54) NETWORK MULTIPLE ANTENNA TRANSMISSION EMPLOYING AN X2 INTERFACE

(75) Inventors: Sandeep Bhadra, Addison, TX (US); Ramanuja Vedantham, Dallas, TX (US); Shantanu Kangude, Dallas, TX (US); Eko N. Onggosanusi, Allen, TX (US); Anand G. Dabak, Plano, TX (US); Badri N. Varadarajan, Dallas, TX (US); Runhua Chen, Dallas, TX (US); Tarkesh Pande, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/561,990

(22) Filed: Sep. 17, 2009

Related U.S. Application Data
(60) Provisional application No. 61/097,788, filed on Sep. 17, 2008.

(51) Int. Cl. H04B 7/02

(52) U.S. Cl. 375/267

(57) ABSTRACT

A coordinated multipoint transmitter is for use with a multiple antenna super-cell and includes primary and secondary base stations jointly connected via an X2 interface link, wherein the primary base station provides a transmission directive corresponding to an X2 interface protocol over the X2 interface link to the secondary base station for a joint transmission from the primary and secondary base stations.

### CROSS-REFERENCE TO RELATED APPLICATION

This application claims the benefit of U.S. Provisional Application Serial No. 61,097,788, filed by Sandeep Bhadra, et al. on Sep. 17, 2008, entitled “A CASE FOR A FASTER USER-PLANE OVER X2 IN LTE-A,” commonly assigned with this application and incorporated herein by reference.

### TECHNICAL FIELD

This application is directed, in general, to a communication system and, more specifically, to a coordinated multipoint transmitter and methods of operating a coordinated multipoint transmitter and a coordinated transmission receiver.

### BACKGROUND

In a cellular network, such as one employing orthogonal frequency division multiple access (OFDMA), each cell employs a base station that communicates with user equipment. Multiple antenna communication systems offer large increases in throughput due to their ability to support multiple parallel data streams that are each transmitted from different antennas. Theses systems provide increased data rates and reliability by exploiting a spatial multiplexing gain or spatial diversity gain that is available to multiple antenna channels. Although current data rates are adequate, improvements in this area would prove beneficial in the art for projected future demand.

### SUMMARY

Embodiments of the present disclosure provide a coordinated multipoint transmitter and methods of operating a coordinated multipoint transmitter and a coordinated transmission receiver. In one embodiment, the coordinated multipoint transmitter is for use with a multiple antenna super-cell and includes primary and secondary base stations jointly connected via an X2 interface link, wherein the primary base station provides a transmission directive corresponding to an X2 interface protocol over the X2 interface link to the secondary base station for a joint transmission from the primary and secondary base stations.

In another aspect the method of operating a coordinated multipoint transmitter is for use with a multiple antenna super-cell and includes providing primary and secondary base stations jointly connected via an X2 interface link and providing a transmission directive from the primary base station corresponding to an X2 interface protocol over the X2 interface link to the secondary base station for a joint transmission from the primary and secondary base stations.

In yet another aspect, the method of operating a coordinated transmission receiver is for use with a multiple antenna super-cell and includes receiving a joint transmission from two base stations that employ different time-frequency resources and processing the joint transmission employing the different time-frequency resources to provide a receive signal based on pooled reception information.

### BRIEF DESCRIPTION

Reference is now made to the following descriptions taken in conjunction with the accompanying drawings, in which:

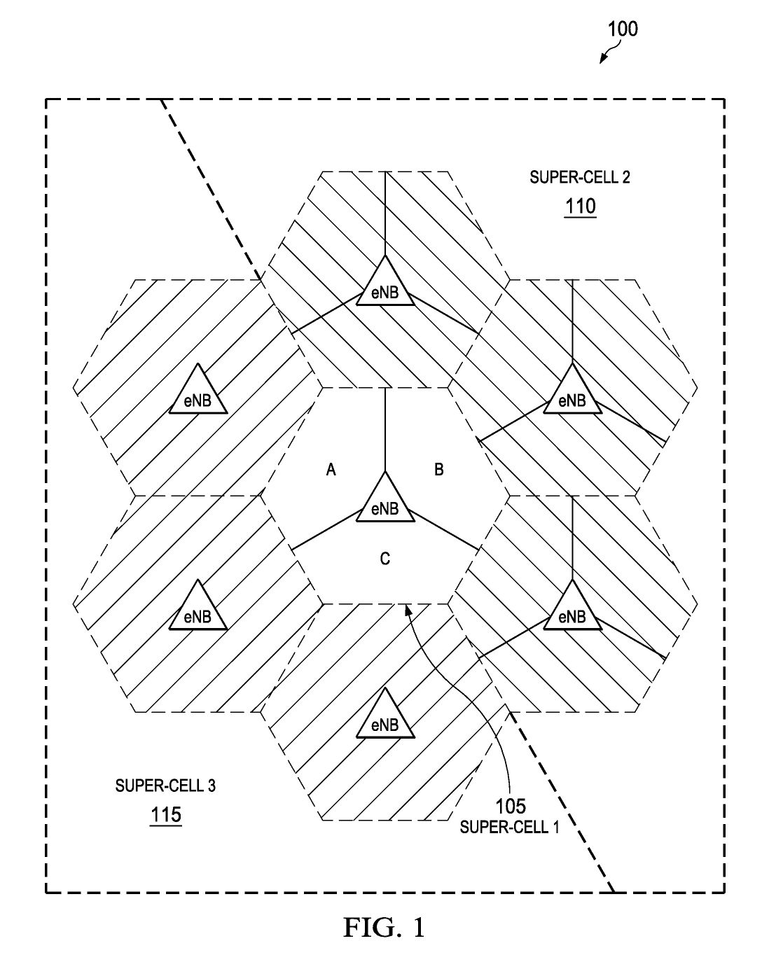

FIG. 1 illustrates a diagram of an exemplary cellular wireless network constructed according to the principles of the present disclosure;

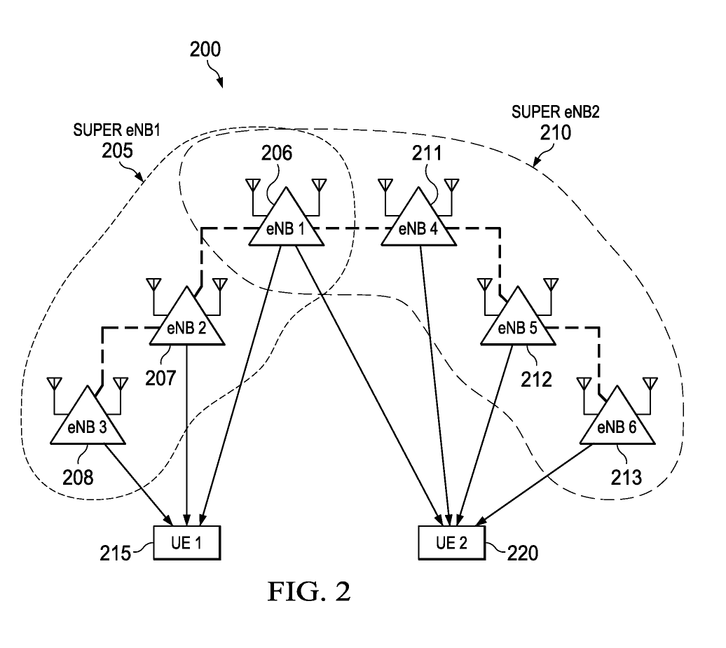

FIG. 2 illustrates a more general example of a network multiple antenna system constructed according to the principles of the present disclosure;

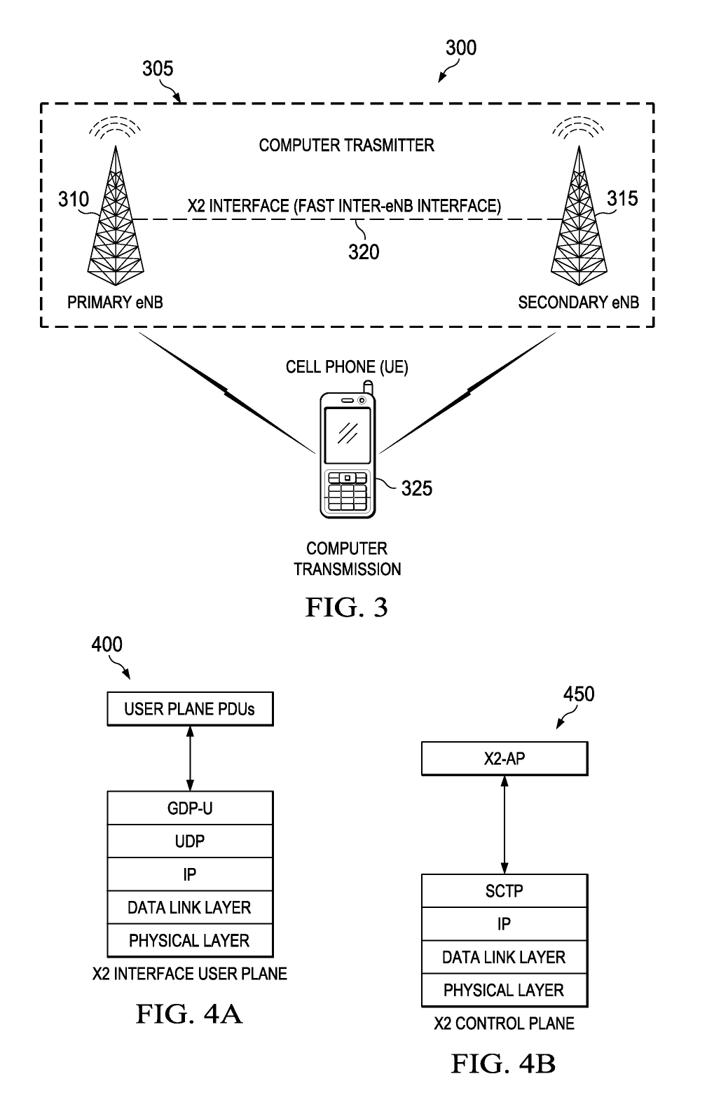

FIG. 3 illustrates a portion of a super cell that provides a coordinated multipoint (COMP) transmission constructed according to the principles of the present disclosure;

FIGS. 4A and 4B illustrate examples of X2 interface user plane and control plane layers as may be employed between peer base stations;

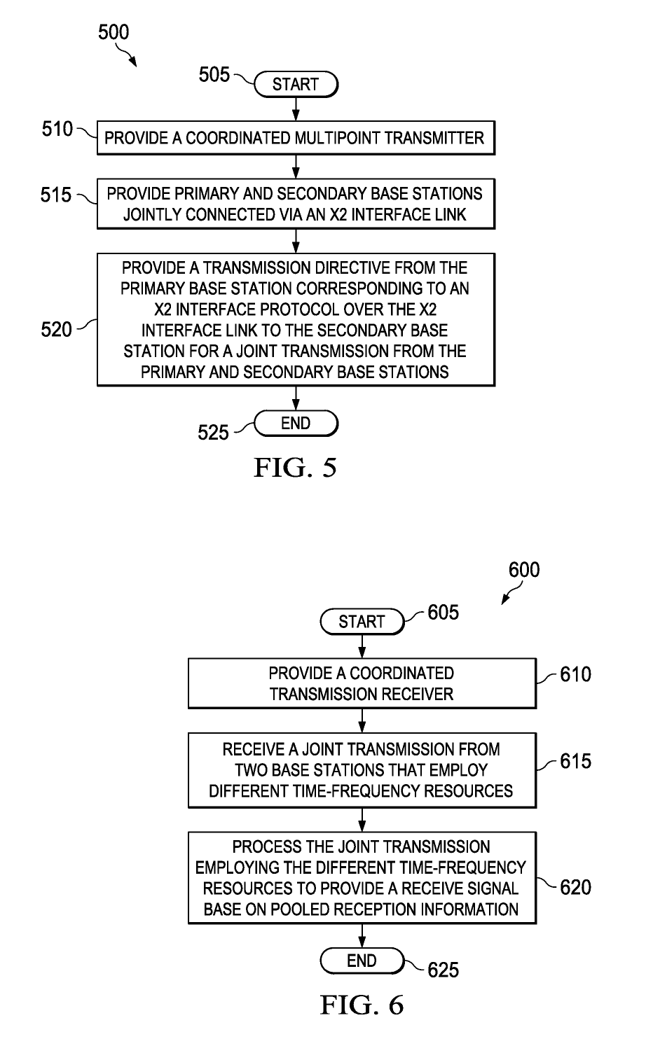

FIG. 5 illustrates a flow diagram of an embodiment of a method of operating a coordinated multipoint transmitter carried out according to the principles of the present disclosure; and

FIG. 6 illustrates a flow diagram of an embodiment of a method of operating a coordinated transmission receiver carried out according to the principles of the present disclosure.

### DETAILED DESCRIPTION

FIG. 1 illustrates a diagram of an exemplary cellular wireless network 100 constructed according to the principles of the present disclosure. The cellular wireless network 100 includes a cellular grid having multiple cells or sectors. Note that a cell is defined as a geographic area where UEs are served by a single network identity (e.g., a base station). The cellular wireless network 100 is representative of a base station network multiple antenna structure that is divided into a plurality of “super-cells” 105, 110, 115, where a super-cell consists of a cluster of cells or sectors. Each of the super-cells employs a coordinated multipoint (COMP) transmitter.

Depending on the cell and network topology, multiple cells may be associated with a single base station (eNB), such as the first super-cell 105. For example in FIG. 1, each of the three sectors A, B, C may also be defined as a cell. In this example, a super-cell is formed from the three sectors A, B, C associated with a single eNB, as shown. That is, one eNB may send three different signals, where each of the three different signals is associated with a separate sector.

Alternatively, it is possible to form a super-cell consisting of two or more cells, where each cell is associated with a different eNB, as shown for the second and third super-cells 110, 115. In the illustrated example, the second super-cell 110 may also employ individual sectors for each of the cells, as noted above. In practice, a cell can be of any physical shape and is not restricted to be a hexagon.

FIG. 2 illustrates a more general example of a network multiple antenna system 200 constructed according to the principles of the present disclosure. The network multiple antenna system 200 includes first and second super-cells 205, 210, and first and second user equipment (UE) 215, 220. The first super-cell 205 employs a first cluster or set of eNBs (i.e., a “super eNB”) that includes first, second and third eNBs 206, 207, 208. Correspondingly, the second super-cell 210 employs a second cluster or set of eNBs that includes the first eNB 106 and fourth, fifth and sixth eNBs 211, 212, 213.

As seen in FIG. 2, the number of eNBs associated with each super eNB can be different. Additionally, it is possible to configure the number and indices of eNBs associated with each super eNB based on network topologies, which may include for example, cell size or traffic type (i.e., highly-loaded cells versus lowly-loaded cells).

Generally, the feasibility of a COMP transmission relies, to a great extent, on the availability of a low-latency, high-throughput link between cooperating cells or eNBs. For the case of cooperating cells belonging to a same eNB, this link may essentially correspond to a backplane connecting the various cells to the eNB. As a comparison, backplane designs in contemporary high speed routers provide link speeds of several hundred Mbps with latencies in the order of microseconds. This provides the availability of low-latency, high-throughput links between cooperating intra-eNB cells for COMP transmissions.

For COMP transmissions to be truly effective on a network-wide scale, it is desirable that COMP transmission strategies be also applicable to cooperating cells belonging to different eNBs. However, in this case, inter-eNB COMP transmissions require the availability of low-latency high-throughput links between the participating eNBs. The network multiple antenna system 200 also includes a fast inter-eNB interface 225 to accomplish this purpose. Current LTE/SAE architecture specifies the X2 interface between peer eNBs, which is an example of such an interface. Therefore, the latency of communications over the X2 interface is an important consideration for the feasibility of COMP transmissions.

FIG. 3 illustrates a portion of a super cell 300 that provides a coordinated multipoint (COMP) transmission constructed according to the principles of the present disclosure. The portion of the super cell 300 includes a COMP transmitter 305 having a primary base station (P-eNB) 310 and a secondary base station (S-eNB) 315 that are connected together by an X2 interface link 320. The COMP transmitter 305 operates as a multiple antenna super eNB and provides the COMP transmission to user equipment (UE) 325.

In the COMP transmitter 305 the primary and secondary eNBs 310, 315 are jointly connected to the X2 interface link 320, wherein the primary eNB 310 provides a transmission directive corresponding to an X2 interface protocol over the X2 interface link 320 to the secondary eNB 315 for a joint transmission from the primary and secondary eNBs 310, 315.

In one embodiment, the primary eNB 310 creates a downlink schedule and signals it to the UE 325 on an appropriate physical (PHY) downlink control channel (PDCCH). An X2 control plane (X2-C) protocol may be used to set up an association between the primary and secondary eNBs 310, 315 for the UE 325 (near a cell boundary, for example). The primary and secondary eNBs 310, 315 may be chosen statically or semi-statically, wherein a change may be accomplished via RRC signaling or a broadcast system parameter (e.g., using the broadcast control channel (BCCH) defined for LTE). Additionally, a choice of primary-secondary association may be either UE-specific or network-specific.

In another embodiment, encapsulated medium access control transport blocks (MAC TBs) are provided directly employing GPRS tunneling protocol-user data tunneling/multiprotocol label switching (GTP-U/MPLS) for improving cell boundary transmission delay performance for the UE 325 using an X2 user plane (X2-U). GTP is a group of IP-based communications protocols used to carry general packet radio service (GPRS) within GSM and UMTS. Scheduling information on the PHY control channel is transmitted only by the primary eNB 310. The secondary eNB 315 forwards the MAC TBs using the same time-frequency resource as allocated by the primary eNB 310.

Alternatively, scheduling information on the PHY control channel may be transmitted employing time-frequency resources by the secondary eNB 315 that are independent of the time frequency resources employed be the primary eNB 310. In this case, the UE 325, operating as a coordinated transmission receiver, receives a joint transmission from the primary and secondary eNBs 310,315 that typically employ different time-frequency resources. The UE 325 processes the joint transmission employing the different or independent time-frequency resources to provide a receive signal based on pooled reception information.

In yet another embodiment, the primary eNB 310 processes uplink (UL) control information and determines the transmitted precoding matrix indicator (TPMI) or transmitted rank indicator (TRI) and the transport block size (TBS) information for the secondary eNB 315 (i.e., generally, each of all cooperating eNBs). This action means that the primary eNB 310 transmits the actual physical layer (PHY) signal to the secondary eNB 315 wherein each may then transmit this PHY signal grant.

Alternatively, PHY uplink control data (e.g., a precoding matrix indicator (PMI), a channel quality indicator (CQI) or a rank indicator (RI)) to be shared from the primary eNB 310 to the secondary eNB 315 (in general, multiple secondary eNBs) may potentially be transmitted either on the X2 interface link 320 user interface (X2-U) or the X2 interface link 320 control interface (X2-C). User plane data that is shared between the primary and secondary eNBs 310, 315 is a MAC TB, which facilitates a reduction in delay times. Each sending eNB (i.e., P-eNB 310, S-eNB 315 in this example) individually converts the MAC TB to a PHY modulated signal.

In a further embodiment, the primary eNB 310 may schedule a time-frequency resource a few transmission time intervals (TTIs) ahead of the time required for the COMP transmission to ensure that the secondary eNB 315 receives the TB sufficiently before scheduling allocation. Of course, one skilled in the pertinent art will recognize that any workable combination of the concepts presented above provides an additional embodiment of the present disclosure.

Now, attention is generally directed toward latency areas associated with use of an X2 interface link (such as the X2 interface link 320) for providing COMP transmissions. Consider a simple COMP transmission strategy where a primary eNB schedules one or more secondary eNBs to cooperatively transmit a TB generated at the primary eNB. In this case, the TB at the MAC layer of the primary eNB (call this primary MAC layer, MAC_{—}1) will be sent to the MAC layer(s) of the respective secondary eNB(s) (call this secondary MAC layer, MAC_{—}2, etc.). Since the MAC layer is between the PHY layer and X2, the latency of sending a TB from MAC_{—}1 to MAC_{—}2 may be computed as shown in equation (1) below.

T_{MACtoMAC}=T_{Uu→X2}+T_{X2}+T_{X2→Uu},

where
T_{Uu→X2}=Delay in conversion from Mt to X2 user plane (X2-U);
T_{X2-U}=Packet Transfer delay over X2 user plane (X2-U); and
T_{X2→Uu}=Delay in conversion from X2 user plane (X2-U) to Uu.

Next, average and maximum backhaul delays (i.e., X2 interface delays) between a cooperative eNB and its nearest neighbors are addressed. A maximum backhaul delay for control plane messages on the X2 interface averages about 20 ms. However it may be noted that this is not a strict upper bound in the sense that larger values may occur in rare scenarios. A typical average delay is expected to be in the region of 10 ms. These values are for control plane messages and not for user plane messages, which use different protocols.

FIGS. 4A and 4B illustrate examples of X2 interface user plane and control plane layers 400, 450 as may be employed between peer base stations. The X2 interface user plane layers 400 and X2 interface control plane layers 450 conform to the 3GPP TS 36.300 specification and are presented as appropriate examples. Each layer is a collection of conceptually similar functions that provide services to the layer above it and receives services from the layer below it. As may be seen, the X2 interface user plane 400 uses GTP whereas the X2 interface control plane 450 uses stream control transmission protocol (SCTP). SCTP is an end-to-end, connection-oriented protocol that transports data in independent sequenced streams. SCTP has higher reliability but is a slower protocol. As will be shown subsequently, an X2 interface user plane latency of T_{MACtoMAC}=3 ms can be achieved using the current GTP-based X2 interface protocol.

S1 interface user (S1-U) and X2 interface user (X2-U) planes have the same protocol in order to minimize protocol processing for the eNB at a time of data forwarding. Analogously, S1 interface control (S1-C) and X2 interface control (X2-C) have the same protocol. The eNBs connect to the core network through the S1 interface.

Table 1 and Table 2 illustrate C-plane and U-plane analysis over the S1 interface. In Tables 1 and 2, a timing analysis is provided that assumes an FDD frame structure and an anticipated information flow. The analysis illustrates that the requirement for the state transition from LTE IDLE to LTE ACTIVE can be achieved within 100 ms.

TABLE 1
Control Plane (C-plane) Latency Analysis

| Step | Description | Duration | |
|---|---|---|---|
| 0 | UE wakeup time | Implementation | |
| | | Dependent | |
| 1 | Average delay due to RACH | 5 | ms |
| | scheduling period | | |
| 2 | RACH Preamble | 1 | ms |
| 3 | Preamble detection and transmission | 5 | ms |
| | of RA response (Time between the | | |
| | end RACH transmission and UE's | | |
| | reception of scheduling grant and | | |
| | timing adjustment) | | |
| 4 | UE Processing Delay (decoding of | 2.5 | ms |
| | scheduling grant, timing alignment | | |
| | and C-RNTI assignment +L1 encoding | | |
| | of RRC Connection Request | | |
| 5 | TTI for transmission of RRC | 1 | ms |
| | Connection Request | | |
| 6 | HARQ Retransmission (@30%) | 0.3*5 | ms |
| 7 | Processing delay in eNB (Uu → S1-C) | 4 | ms |
| 8 | S1-C Transfer delay | Ts1c (2 ms-15 ms) | |
| 9 | MME Processing Delay (including UE | 15 | ms |
| | context retrieval of 10 ms) | | |
| 10 | S1-C Transfer delay | Ts1c (2 ms-15 ms) | |
| 11 | Processing delay in eNB (S1-C → Uu) | 4 | ms |
| 12 | TTI for transmission of RRC | 1.5 | ms |
| | Connection Setup (+Average | | |
| | alignment) | | |
| 13 | HARQ Retransmission (@30%) | 0.3*5 | ms |
| 14 | Processing delay in UE | 3 | ms |
| 15 | TTI for transmission of L3 RRC | 1 | ms |
| | Connection Complete | | |
| 16 | HARQ Retransmission (@30%) | 0.3*5 | ms |

| | |
|---|---|
| Total LTE IDLE → ACTIVE delay (C- | 47.5 ms + 2*Ts1c |
| plane establishment delay) | |

TABLE 2
User Plane (U-plane) Latency Analysis

| Step | Description | Duration | |
|---|---|---|---|
| | LTE_IDLE→LTE_ACTIVE delay (C- | 47.5 ms + 2*Ts1c | |
| | plane establishment) | | |
| 17 | TTI for UL DATA PACKET (Piggy back | 1 | ms |
| | scheduling information) | | |
| 18 | HARQ Retransmission (@30%) | 0.3*5 | ms |
| 19 | eNB Processing Delay (Uu → S1-U) | 1 | ms |
| | U-plane establishment delay (RAN | 51 ms + 2*Ts1c | |
| | edge node) | | |
| 20 | S1-U Transfer delay | Ts1u (1 ms-15 ms) | |
| 21 | UPE Processing delay (including | 10 | ms |
| | context retrieval) | | |

| | |
|---|---|
| U-plane establishment delay | 61 ms + 2*Ts1c + |
| (Serving GW) | Ts1u |

It may be noted that the processing delays for each of Uu→S1-C and S1-C→Uu is 4 ms (from Table 1, rows 7 and 11). Since the protocol is the same for X2-C and S1-C, it is expected that delay in conversion from X2-C to Uu, and vice versa, will each be 4 ms. Thus, the control plane latency is on average, 8 ms+T_{X2-C}, where T_{X2-C} is the packet transfer delay on the control plane. Assuming a nominal T_{x2-C} of 2 ms (from Table 1, row 8), this matches the average X2 latency value for the control plane. However, using the U-plane latency values in Table 2, it is estimated that T_{Uu→X2} and T_{X2→Uu} are each about 1 ms. Using a nominal packet transfer delay T_{X2-U} of 1 ms (see Table 2, row 20), T_{MACtoMAC}=3 ms for the X2 interface user plane.

Finally, estimates of required packet transfer delay T_{X2-U} and X2 bandwidth are analyzed. Packet transfer delay may be decomposed according to the relationship: packet transfer delay equals queuing delay plus transmission delay plus propagation delay. Nodal processing delay is the time required to process packets at either end of the link. Queuing delay is the head of line delay at a source router queue where a packet to be processed is waiting for other packets before it to be processed. Transmission delay equals packet size per link bandwidth, and propagation delay is length of link divided by the speed of light. Since propagation delays are order-wise smaller quantities, they may be ignored. For a standard TB of size 2 KB and using a 100 Mbps link, the transmission delay is approximately 150 microseconds per TB.

Now, to ensure that there is negligible queuing delay, the X2 interface link is required to be well provisioned in terms of X2 bandwidth. The X2 interface may be considered to be well provisioned to avoid any significant queuing delay when the total nominal downlink Uu-bit rate is approximately 85 percent larger than the nominal X2 interface link bit rate.

FIG. 5 illustrates a flow diagram of an embodiment of a method of operating a coordinated multipoint transmitter 500 carried out according to the principles of the present disclosure. The method 500 is for use with a multiple antenna super-cell and starts in a step 505. Then, in a step 510, a coordinated multipoint transmitter is provided. Primary and secondary base stations are provided that are jointly connected via an X2 interface link, in a step 515. A transmission directive from the primary base station corresponding to an X2 interface protocol over the X2 interface link to the secondary base station for a joint transmission from the primary and secondary base stations is provided in a step 520.

In one embodiment, paring and ordering of the primary and secondary base stations is accomplished on a network-specific basis that is static or semi-static or on a UE-specific basis. In another embodiment, X2 interface link corresponds to a wired connection or a wireless connection employing the X2 interface protocol that conforms to an X2 interface user plane or an X2 interface control plane.

In yet another embodiment, the transmission directive corresponds to a medium access control transport block (MAC TB) that is encapsulated directly using an X2 interface user plane. Additionally, the secondary base station employs the MAC TB using a same time-frequency resource as allocated by the primary base station. Further, the same time-frequency resource is scheduled far enough ahead of the joint transmission to compensate for delays provided by the X2 interface link.

In still another embodiment, the transmission directive instructs the secondary base station to provide scheduling information using a time-frequency resource that is independent of one used by the primary base station for the joint transmission. In a further embodiment, only the primary base station processes uplink control information for use by the secondary base station and the transmission directive corresponds to sending a physical layer modulated block over the X2 interface link. In a still further embodiment, uplink control information is shared by the primary base station with the secondary base station using an X2 interface user plane or an X2 interface control plane. The method 500 ends in a step 525.

FIG. 6 illustrates a flow diagram of an embodiment of a method of operating a coordinated transmission receiver 600 carried out according to the principles of the present disclosure. The method 600 is for use with a multiple antenna super-cell and starts in a step 605. Then, in a step 610, a coordinated transmission receiver is provided and a joint transmission is received from two base stations that employ different time-frequency resources, in a step 615. The joint transmission is processed employing the different time-frequency resources to provide a receive signal based on pooled reception information, in a step 620. In one embodiment, the receive signal based on the pooled reception information corresponds to the joint transmission employing a MAC TB. The method ends in a step 625.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A coordinated multipoint transmitter for use with a multiple antenna super-cell, comprising:
primary and secondary base stations jointly connected via an X2 interface link, wherein the primary base station provides a transmission directive corresponding to an X2 interface protocol over the X2 interface link to the secondary base station for a joint transmission from the primary and secondary base stations.

2. The transmitter as recited in claim 1 wherein the X2 interface link corresponds to a wired connection or a wireless connection employing the X2 interface protocol that conforms to an X2 interface user plane or an X2 interface control plane.

3. The transmitter as recited in claim 1 wherein paring and ordering of the primary and secondary base stations is accomplished on a network-specific basis that is static or semi-static or on a UE-specific basis.

4. The transmitter as recited in claim 1 wherein the transmission directive corresponds to a medium access control transport block (MAC TB) that is encapsulated directly using an X2 interface user plane.

5. The transmitter as recited in claim 4 wherein the secondary base station employs the MAC TB using a same time-frequency resource as allocated by the primary base station.

6. The transmitter as recited in claim 5 wherein the same time-frequency resource is scheduled far enough ahead of the joint transmission to compensate for delays provided by the X2 interface link.

7. The transmitter as recited in claim 1 wherein the transmission directive instructs the secondary base station to provide scheduling information using a time-frequency resource that is independent of one used by the primary base station for the joint transmission.

8. The transmitter as recited in claim 1 wherein only the primary base station processes uplink control information for use by the secondary base station and the transmission directive corresponds to sending a physical layer modulated block over the X2 interface link.

9. The transmitter as recited in claim 1 wherein uplink control information is shared by the primary base station with the secondary base station using an X2 interface user plane or an X2 interface control plane.

10. A method of operating a coordinated multipoint transmitter for use with a multiple antenna super-cell, comprising:
providing primary and secondary base stations jointly connected via an X2 interface link; and
providing a transmission directive from the primary base station corresponding to an X2 interface protocol over the X2 interface link to the secondary base station for a joint transmission from the primary and secondary base stations.

11. The method as recited in claim 10 wherein the X2 interface link corresponds to a wired connection or a wireless connection employing the X2 interface protocol that conforms to an X2 interface user plane or on an X2 interface control plane.

12. The method as recited in claim 10 wherein paring and ordering of the primary and secondary base stations is accomplished on a network-specific basis that is static or semi-static or a UE-specific basis.

13. The method as recited in claim 10 wherein the transmission directive corresponds to a medium access control transport block (MAC TB) that is encapsulated directly using an X2 interface user plane.

14. The method as recited in claim 13 wherein the secondary base station employs the MAC TB using a same time-frequency resource as allocated by the primary base station.

15. The method as recited in claim 14 wherein the same time-frequency resource is scheduled far enough ahead of the joint transmission to compensate for delays provided by the X2 interface link.

16. The method as recited in claim 10 wherein the transmission directive instructs the secondary base station to provide scheduling information using a time-frequency resource that is independent of one used by the primary base station for the joint transmission.

17. The method as recited in claim 10 wherein only the primary base station processes uplink control information for use by the secondary base station and the transmission directive corresponds to sending a physical layer modulated block over the X2 interface link.

18. The method as recited in claim 10 wherein uplink control information is shared by the primary base station with the secondary base station using an X2 interface user plane or an X2 interface control plane.

19. A method of operating a coordinated transmission receiver for use with a multiple antenna super-cell, comprising:
receiving a joint transmission from two base stations that employ different time-frequency resources; and
processing the joint transmission employing the different time-frequency resources to provide a receive signal based on pooled reception information.

20. The method as recited in claim 19 wherein the receive signal based on the pooled reception information corresponds to the joint transmission employing a MAC TB.
